(19) United States
(12) Patent Application Publication
(10) Pub. No.: US 2017/0264775 A1
(43) Pub. Date: Sep. 14, 2017

(54) IMAGE PROCESSING APPARATUS, METHOD OF CONTROLLING THE SAME, AND STORAGE MEDIUM

(71) Applicant: CANON KABUSHIKI KAISHA, Tokyo (JP)

(72) Inventor: Atsushi Ikeda, Toride-shi (JP)

(21) Appl. No.: 15/449,289

(22) Filed: Mar. 3, 2017

(30) Foreign Application Priority Data
Mar. 10, 2016 (JP) 2016-047367

(51) Int. Cl. H04N 1/32; H04N 1/21; H04N 1/00

(52) U.S. Cl. CPC H04N 1/32069; H04N 1/00228; H04N 1/2166; H04N 1/32529; H04N 1/0022; H04N 2201/0094; H04N 2201/0039

(57) ABSTRACT

An image processing apparatus sets, as storage destinations for storing image data as a transmission history, a first external storage destination and a second external storage destination; accepts a transmission destination of image data; transmits image data to the transmission destination accepted by the acceptance unit; and stores the image data in the first external storage destination in accordance with the transmission destination of the image data not being a specific destination, and stores the image data to the second external storage destination in accordance with the transmission destination of the image data being the specific destination.

### BACKGROUND OF THE INVENTION

Field of the Invention

The present invention relates to an image processing apparatus, a method of controlling the same, and a storage medium.

Description of the Related Art

There are image processing apparatuses that have a function for transmitting an image read from an original to an external apparatus. In Japanese Patent Laid-Open No. 2011-139272, an apparatus that transmits image data to a counterparty that a user designated, and also saves, as archive data, that image data to a destination set in advance is proposed.

However, there is a problem as is recited below in the foregoing conventional technique. For example, with the foregoing conventional technique, it is only possible to designate one destination to be an archive destination. Specifically, archive content is frequently searched for image data transmitted to a casualty insurance company, and while there is a desire to archive to a second destination that is different to a preset destination, it is not possible to realize that with the foregoing conventional technique. In the foregoing conventional technique, it is possible to register a specific counterparty to a routine task button and perform a one-touch facsimile transmission, but the archive destination is the destination set in advance as described above.

Meanwhile, a method of using a broadcast function and designating a plurality of counterparties can be considered. In the previously described example, for instance, it is possible to achieve the objective by, when transmitting to a casualty insurance company, selecting the casualty insurance company for one counterparty, and selecting a second destination different to the archive destination set in advance as a broadcast destination.

However, the following problems exist in the case where a broadcast function is used. One is that the capacity of the storage apparatus for archiving is limited in a relatively small scale office. Because the same image data is archived both at the destination set in advance and at the second destination that is designated as the broadcast destination, storage apparatus consumption is doubled. Another problem is that broadcasts cannot be made by different protocols in relatively low-price image processing apparatuses. For example, a case in which the counterparty that the user designates is a facsimile machine, and the destination for archiving is desired to be a Common Internet File System (CIFS) folder cannot be handled using a broadcast function.

### SUMMARY OF THE INVENTION

The present invention enables realization of a mechanism for storing image data in an external storage destination that is different from normal when transmitting image data to a specific destination.

One aspect of the present invention provides an image processing apparatus, comprising: a setting unit configured to set, as storage destinations for storing image data as a transmission history, a first external storage destination and a second external storage destination; an acceptance unit configured to accept a transmission destination of image data; a transmission unit configured to transmit image data to the transmission destination accepted by the acceptance unit; and a storage control unit configured to store the image data in the first external storage destination in accordance with the transmission destination of the image data not being a specific destination, and to store the image data to the second external storage destination in accordance with the transmission destination of the image data being the specific destination.

Another aspect of the present invention provides a control method for controlling an image processing apparatus comprising: setting, as storage destinations for storing image data as a transmission history, a first external storage destination and a second external storage destination; accepting a transmission destination of image data; transmitting image data to the accepted transmission destination; and storing the image data in the first external storage destination in accordance with the transmission destination of the image data not being a specific destination, and storing the image data to the second external storage destination in accordance with the transmission destination of the image data being the specific destination.

Still another aspect of the present invention provides a non-transitory computer readable storage medium for storing a computer program for controlling an image processing apparatus, the computer program comprising: code that sets, as storage destinations for storing image data as a transmission history, a first external storage destination and a second external storage destination; code that accepts a transmission destination of image data; code that transmits image data to the accepted destination; and code that stores the image data in the first external storage destination in accordance with the transmission destination of the image data not being a specific destination, and stores the image data to the second external storage destination in accordance with the transmission destination of the image data being the specific destination.

Further features of the present invention will be apparent from the following description of exemplary embodiments with reference to the attached drawings.

### BRIEF DESCRIPTION OF THE DRAWINGS

FIG. 1 is a schematic view illustrating a use environment of an image processing apparatus according to an embodiment (MFP).

FIG. 2 is a block diagram illustrating a hardware configuration of the MFP according to an embodiment.

FIG. 3 is a software configuration diagram of the MFP according to an embodiment.

FIG. 4 is a view illustrating an example of a screen for performing settings of communication management according to an embodiment.

FIG. 5 is a flowchart illustrating operation of a normal facsimile transmission reservation according to an embodiment.

FIG. 6 is a flowchart illustrating operation of the facsimile transmission according to an embodiment.

FIG. 7 is a view illustrating an example of a screen for performing setting of facsimile transmission and archiving to specific destinations according to an embodiment.

FIG. 8 is a view illustrating an example of a home screen on which a button for facsimile transmission and archiving to specific destinations is displayed, according to an embodiment.

FIG. 9 is a flowchart illustrating operation of a reservation of facsimile transmission and archiving to specific destinations according to an embodiment.

FIG. 10 is a flowchart indicating operation of a framework of a VM/FW unit 309 when a power supply is turned ON according to an embodiment.

FIG. 11 is a view illustrating a concept of a non-volatile region provided by a Storage unit.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

<Use Environment of Image Processing Apparatus>

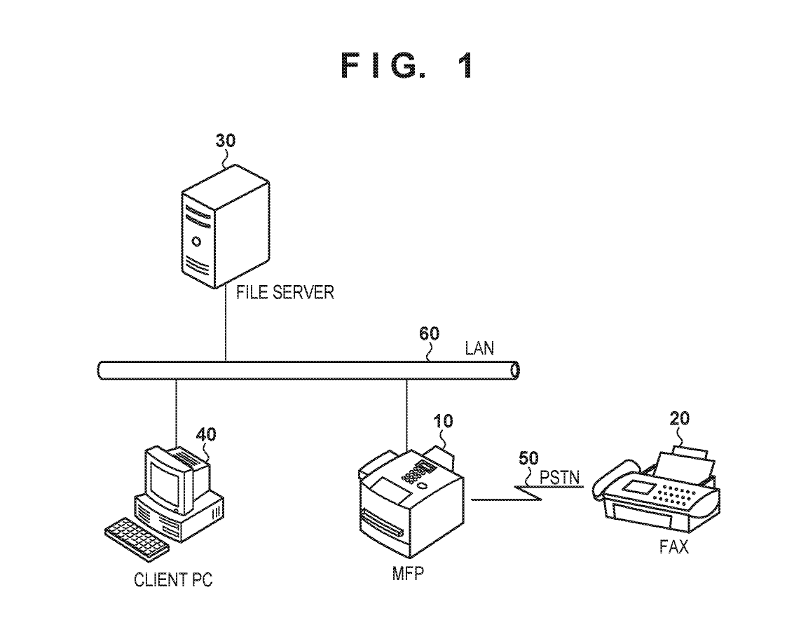

Below, description will be given for a first embodiment of the present invention. First, description will be given for the use environment of the image processing apparatus (the MFP) referring to the FIG. 1. MFP 10 is connected to a telephone public circuit network (PSTN) 50 and can perform facsimile transmission and reception with a facsimile machine (Fax) 20 via the PSTN 50. Below, the facsimile is referred to as simply Fax. Also, the MFP 10 is connected to a file server 30 via a LAN 60. The MFP 10 can save an image for which a facsimile transmission is performed in the file server 30, as is described later.

Also, the MFP 10 is connected with a client PC 40 via the LAN 60, and a user can change settings of the MFP 10 using a Web browser on the client PC 40. Note that in FIG. 1, an example is illustrated in which a single Fax 20 is connected to the MFP 10 via the PSTN 50, but there need not be only one Fax. That is, the MFP 10 can communicate with multiple Faxes via the PSTN 50. Similarly, a plurality of the file server 30 and the client PC 40 may be provided.

<Hardware Configuration>

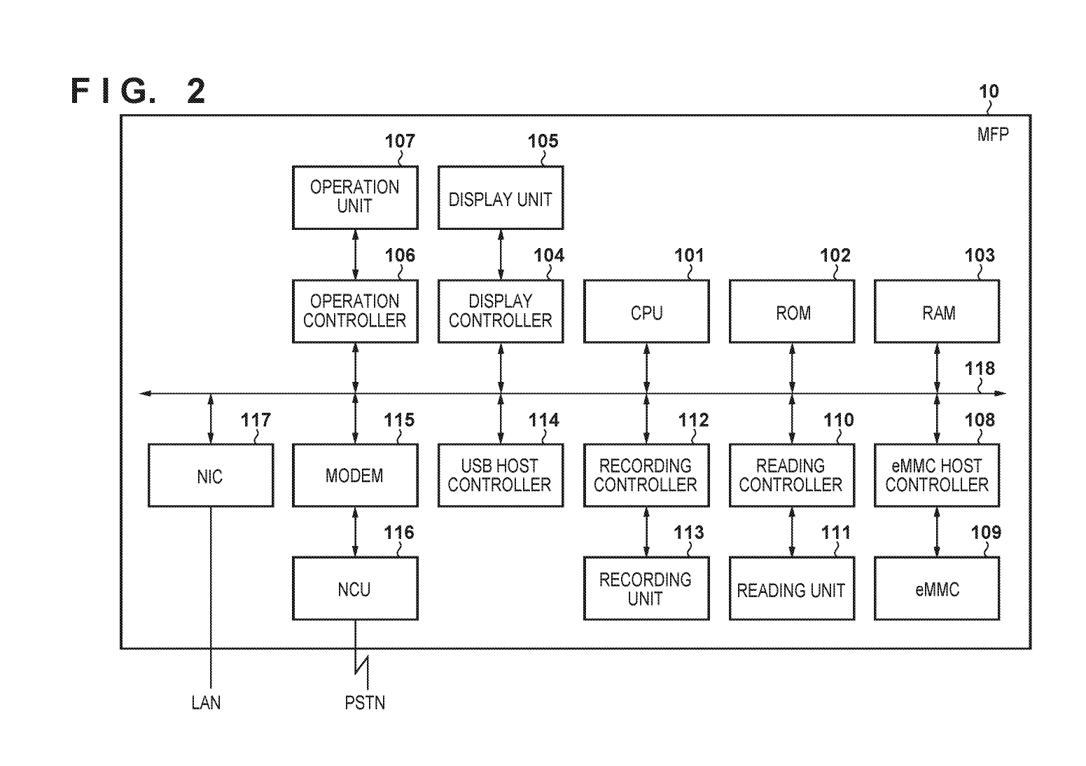

Next, with reference to FIG. 2, a hardware configuration of the MFP 10 according to embodiments is described. As illustrated in FIG. 2, the MFP 10 comprises a CPU 101, a ROM 102, a RAM 103, a display controller 104, a display unit 105, an operation controller 106, and an operation unit 107. Also, the MFP 10 comprises an eMMC host controller 108, an eMMC 109, a reading controller 110, a reading unit 111, a recording controller 112, and a recording unit 113. Furthermore, the MFP 10 comprises a USB host controller 114, a modem 115, a network control unit (NCU) 116, and a network interface card (NIC) 117.

The CPU 101 comprehensively controls each device connected to a system bus 118. The CPU 101 executes a boot program stored in the ROM 102 when a power supply is supplied. Usually, the boot program loads a main program saved in a storage into the RAM 103, and jumps to the head of the loaded main program. The RAM 103 functions not only as a load location for the main program, but also as a work area for the main program or the like.

The display controller 104 controls rendering for the display unit 105. The display unit 105 is an LCD on which a display of a character sequence of 28 characters×7 lines, ruled lines, and a scroll bar for example is possible. Meanwhile, the operation controller 106 controls an input from the operation unit 107 equipped in the MFP 10. The operation unit 107 is equipped with a numeric keypad, a cursor keypad, a one-touch key, and the like.

The reading unit 111 performs a reading of an original. An automatic document feeder (not shown) is attached as an option to the reading unit 111 and can automatically read a plurality of originals. The reading unit 111 connects to the reading controller 110 and the CPU 101 performs exchanges with the reading unit 111 via the reading controller 110.

Also the recording unit 113 performs image formation on a recording sheet (also referred to as a recording medium and a sheet) by the electrophotographic method. The recording unit 113 is connected to the recording controller 112 and the CPU 101 performs exchanges with the recording unit 113 via the recording controller 112. The USB host controller 114 handles USB protocol control and mediates access to a USB device such as a USB memory (not shown). The modem 115 performs a modulation/demodulation of signals necessary for a facsimile communication. Also, the modem 115 is connected to an NCU 116. A signal modulated by the modem 115 is outputted to a telephone public circuit network (PSTN) via the NCU 116.

An NIC 117 performs a bi-directional exchange of data with an email or file server or the like via a LAN. The MFP 10 of the present embodiment is equipped with the eMMC 109 as a storage. The CPU 101 accesses the eMMC 109 via the eMMC host controller 108.

<Software Configuration>

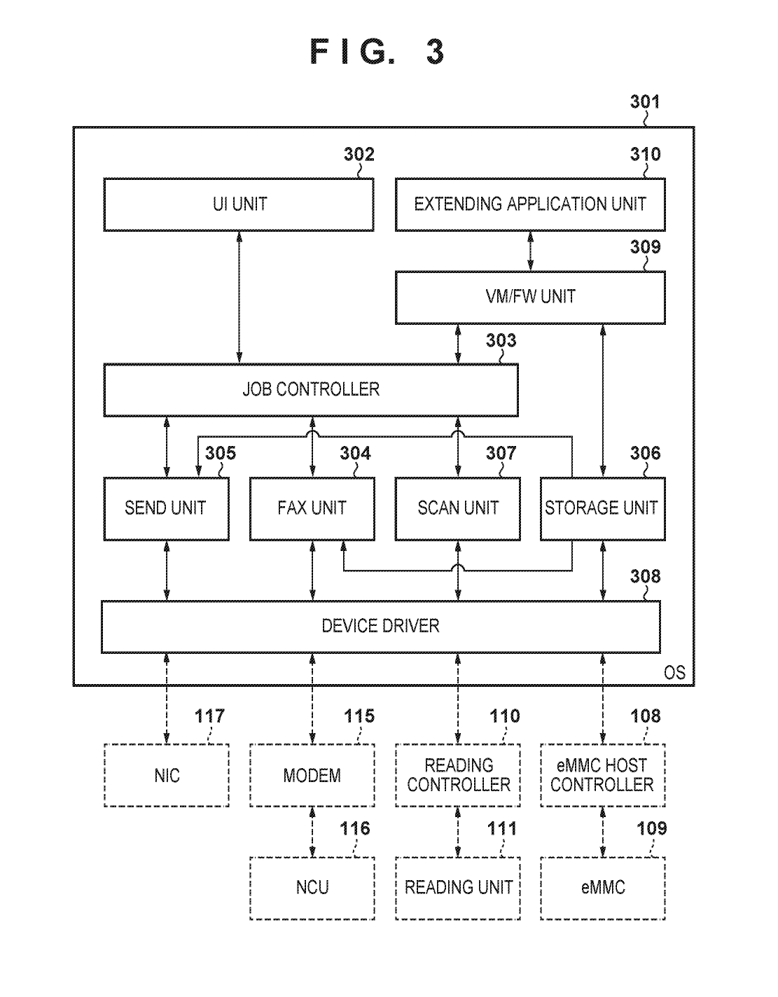

Next, with reference to FIG. 3, a software configuration diagram of the MFP 10 according to embodiments is described. Each unit illustrated by solid lines in FIG. 3 is a software module realized by the CPU 101 executing a main program loaded to the RAM 103 by the previously described boot program.

For the main program, execution of each module described later is managed/controlled by an OS (Operating System) 301. A device driver 308 is combined in the OS 301. The device driver 308 mediates exchanges with a hardware device such as the NIC 117 or the modem 115. A UI (User Interface) unit 302 provides various information to a user via the display unit 105 and the operation unit 107 and also accepts various instructions from the user.

A job controller 303 accepts a job such as for a copy, a print, or a fax and controls execution of the accepted job. A Storage unit 306 is a software module that stores and manages data such as a user setting or an image that is transmitted by fax physically to the eMMC 109. For example, a Scan unit 307 accepts a job request, controls the reading unit 111, and scans an original when the job controller 303 accepts a FAX job in the MFP 10 of the present embodiment. Then, it stores the scanned facsimile image data to the Storage unit 306. The facsimile image data stored in the Storage unit 306 is read by a Fax unit 304 and is transmitted by fax to a counterparty via the modem 115 and the NCU 116.

A Send unit 305 reads an image file stored in the Storage unit 306 and transmits it to an external apparatus (the file server 30 for example) via the NIC 117. A VM (Virtual Machine)/FW (framework) unit 309 is equipped in the MFP 10 of the present embodiment. An extension application unit 310 is configured from a particular program or the like described by a scripting language. The VM/FW unit 309 handles a role of installing a particular program described by a scripting language to the extension application unit 310 or uninstalling from the extension application unit 310. Also, the VM/FW unit 309 handles mediation or the like between a function realized by a particular program installed to the extension application unit 310 and an existing function. Also, the VM/FW unit 309 interprets the described scripting language and executes it. By this, the MFP 10 of the present embodiment can easily realize a particular function such as such as facsimile transmission and archiving to specific counterparties described later while maintaining function detachability.

<Transmission Management Setting Screen Example>

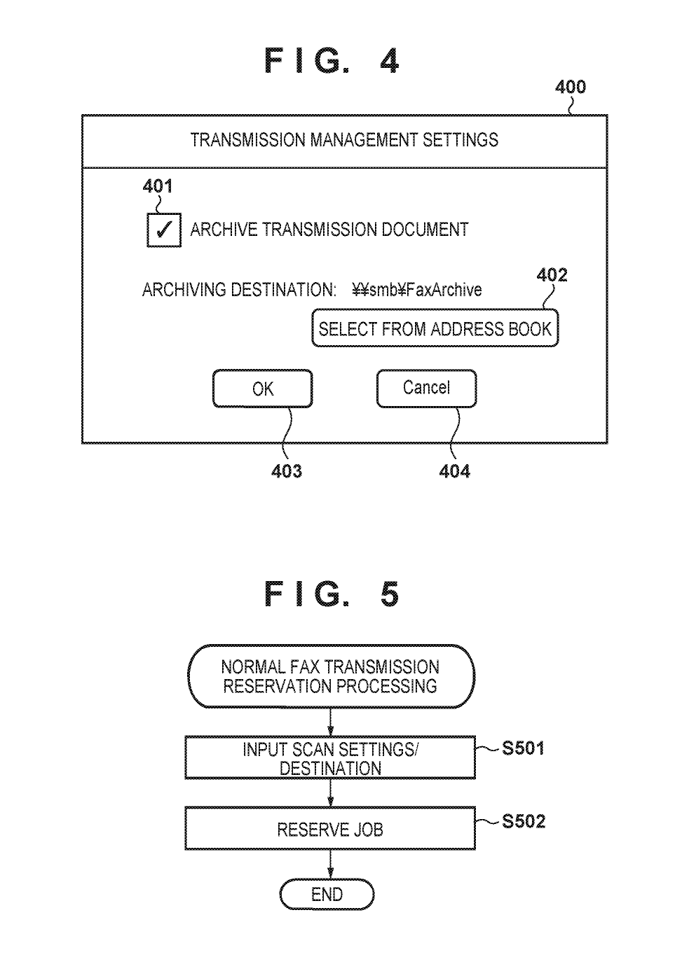

Next, with reference to FIG. 4, description is given of an example of a screen on which communication management settings are performed in an embodiment of the present invention. In the communication management settings, it is possible to switch whether or not to save, as archive data, a document transmitted by fax, and to set an archive destination. Here, the MFP 10 of the present embodiment has an HTTP server function. Also, a setting screen 400 illustrated in FIG. 4 is displayed in the Web browser of the client PC 40 when a specific URL that the HTTP server of the MFP 10 provides is accessed on the Web browser of the client PC 40. Note that the setting screen 400 may also be displayed on the display unit 105.

Also, in an address book of the MFP 10 of the present embodiment, it is possible to register, as a destination, an FTP path, an email address, and a fax number, in addition to a CIFS (Common Internet File System) folder. Also, it is possible to select a particular destination registered in an address book as an archive destination.

A check-box 401 for setting an archiving function for saving a transmission document as archive data to be enabled or disabled, and a button 402 for selecting an archiving destination from an address book are included in the setting screen 400. Furthermore, an OK button 403 for finalizing the content set on the setting screen 400 and a cancel button 404 for canceling are included in the setting screen 400. In the example of the setting screen 400 illustrated in FIG. 4, a state in which a document transmitted by fax is set to be saved as archive data, and “ [symbol] smb [symbol] Fax Archive”, which is a CIFS folder, is selected from an address book as an archive destination is illustrated.

Here, with reference to FIG. 11, description is given for a non-volatile region provided by the Storage unit 306. When the OK button 403 is pressed in the setting screen 400, the setting values for communication management that are set in the setting screen 400 are stored in a non-volatile region 1100. More specifically, they are stored in a region of archive settings 1111 which is assigned in a user setting region (readout region) 1110 that is provided in the non-volatile region 1100 illustrated in FIG. 11. The non-volatile region 1100 has a region for extension applications (extension region) 1120 and a save region 1130 in addition to the foregoing user setting region 1110. Note that the details of the regions other than the non-volatile region 1100 will be described later.

<Reservation and Transmission of Facsimile Transmission to Normal Destination>

Next, with reference to FIG. 5, description is given for a processing procedure for reservation of a normal facsimile transmission in an embodiment of the present invention. Note that the processing described below is realized by the CPU 101 executing a control program that is read from the ROM 102 or another storage unit and loaded into the RAM 103.

When a user selects the facsimile button of the home screen (operation screen) displayed on the display unit 105 or a Web browser of the client PC 40, normal facsimile transmission reservation processing is executed. Firstly, in step S501, the CPU 101 accepts scan settings and a destination inputted by the user. A plurality of destinations can be selected. Also, the scan settings is settings for a resolution, a density, or the like for when reading an original. When input acceptance completes, and the user makes an instruction for the initiation of a job, the processing proceeds to step S502.

In step S502, the CPU 101 makes a reservation to the job controller 303 for a facsimile transmission job for which the scan setting and the destination set in step S501 are made to be parameters, and the processing is terminated. Processing for after reservation is described below.

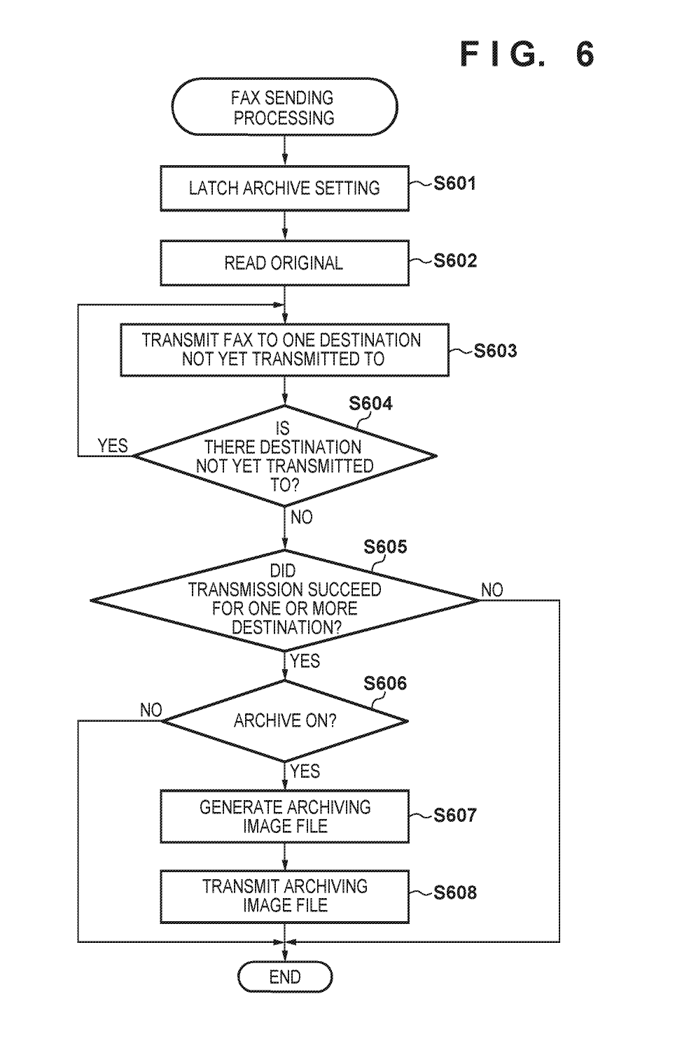

Next, with reference to FIG. 6, description is given for a processing procedure for a facsimile transmission in an embodiment of the present invention. Note that the processing described below is realized by the CPU 101 executing a control program that is read from the ROM 102 or another storage unit and loaded into the RAM 103.

When a reservation for a facsimile transmission job is made to the job controller 303, the facsimile transmission processing is executed in sequence. Firstly, in step S601, the CPU 101 reads a setting value stored in the archive settings 1111 of FIG. 11 from the Storage unit 306, and latches it to use it as a job parameter. It is advantageous that this processing be executed substantially simultaneously to the facsimile transmission job being reserved in step S502.

Next, in step S602, the CPU 101 drives the Scan unit 307 to cause the reading unit 111 to scan an original that has been set. As mentioned previously, scanned facsimile image data is stored in the Storage unit 306. When the scanning completes, the CPU 101 drives the Fax unit 304 in step S603. Then, a facsimile transmission of the facsimile image data stored in the Storage unit 306 is made to one of the destinations selected in step S501. After that, in step S604, the CPU 101 determines whether or not there is still a destination for which facsimile transmission has not started remaining among the destinations selected in step S501. If a destination remains, step S603 is repeated, and if not, the processing proceeds to step S605.

When there are no more destination yet to be transmitted to, the CPU 101, in step S605, determines whether or not the facsimile transmissions in step S603 succeeded for one or more destinations. If transmission succeeded for one or more destinations, the processing proceeds to step S606, and if not, the facsimile transmission processing is terminated.

In step S606, the CPU 101 determines whether or not the archiving setting parameter latched in step S601 is set to save archiving data. The archiving setting referenced here is latched in step S601, so even if the archiving setting is changed during job execution, already reserved jobs are not affected. If there is a setting for saving archiving data, the processing proceeds to step S607, and if not, the facsimile transmission processing is terminated.

In step S607, the CPU 101 drives the Send unit 305, and generates a file by converting the facsimile image data stored in the Storage unit 306 into image data for archive transmission. The generated file is stored in the Storage unit 306. Then, in step S608, the CPU 101 transmits the image data for archive transmission that is stored in the Storage unit 306 to the destination of the archive setting designated when facsimile transmission is reserved. When the archive transmission is complete, the facsimile transmission processing is terminated. Here, the archive transmission means transmitting archiving data of image data that is transmitted by fax to an external apparatus connected so that communication is possible with the MFP 10, and cause the external apparatus to store it.

<Fax and Archive Setting Screen Example>

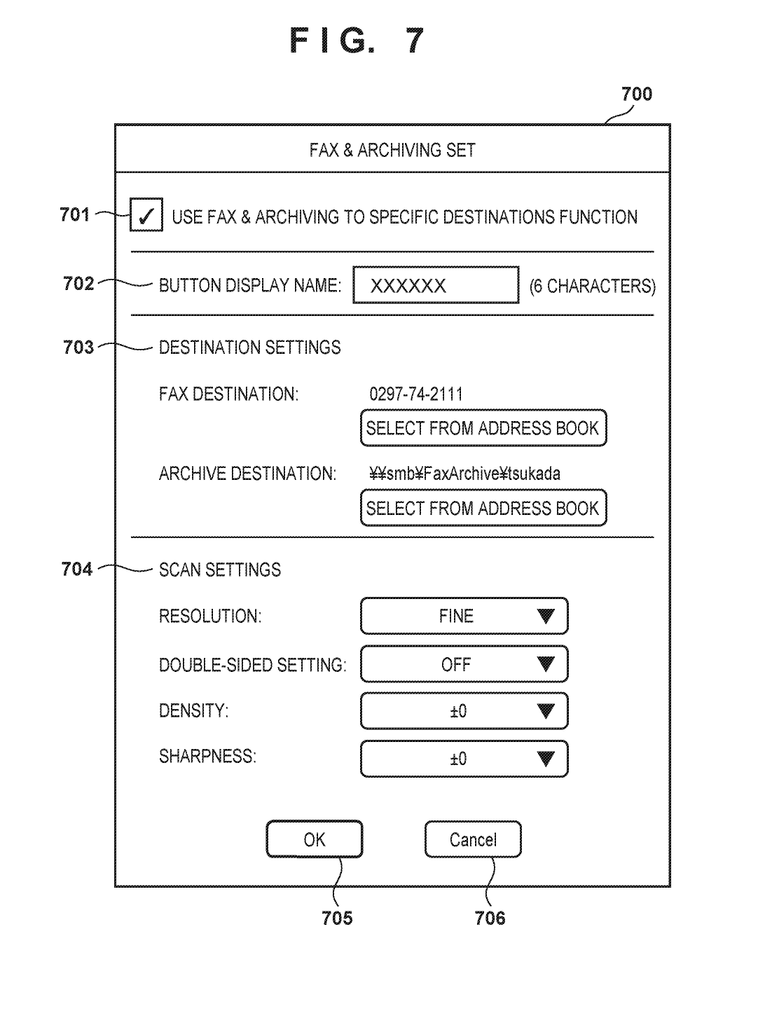

Next, with reference to FIG. 7, an example of a screen for performing setting of facsimile transmission and archiving to specific destinations according to an embodiment of the present invention. Similarly to the setting screen 400 for transmission management settings illustrated in FIG. 4, this screen is displayed when a specific URL that the HTTP server of the MFP 10 provides is accessed by a Web browser of the client PC 40. When the URL is accessed, the MFP 10 provides screen information of this screen to the external apparatus that accessed it. Also, this screen may be displayed on the display unit 105 of the MFP 10. Note that the HTML that represents a setting screen 700 illustrated in FIG. 7 is generated by a servlet script that configures a program for facsimile transmission and archiving to specific destinations that is installed in the extension application unit 310.

As illustrated in FIG. 7, the setting screen 700 is configured from a check-box 701 for setting whether or not to use the facsimile transmission and archiving to specific destinations function, a button display name 702, destination settings 703, and scan settings 704. Furthermore, configuration is such that an OK button 705 for finalizing the content set on the setting screen 700 and a cancel button 706 for canceling are included.

The check-box 701 is set to use the function, and following that it becomes possible to input into the button display name 702, the destination settings 703, and the scan settings 704. Accordingly, in a state in which the check-box 701 is not set, it is made to be impossible to input into the settings 702-704, and they may be displayed to be grayed out.

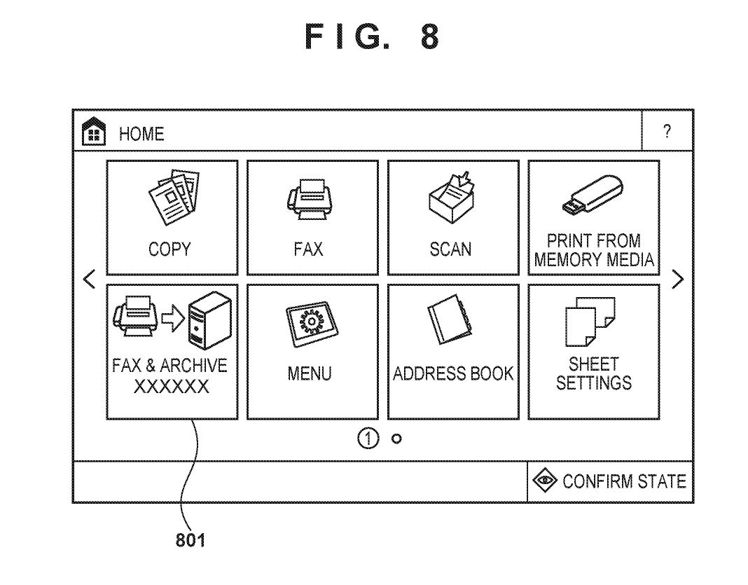

In the button display name 702, a name that is displayed on a button displayed on a home screen (operation screen) illustrated in FIG. 8 described later is set. Configuration is such that in the destination settings 703, a user is allowed to select a facsimile transmission destination and an archive destination from an address book. It is possible to select both destinations from the address book. In the scan settings 704, it is possible to set a resolution for when scanning, a double-sided setting for setting the sides of the original to scan, and the density and sharpness for when scanning. Note that for these setting items, the intention is not to limit the present invention, and other settings may be applied as alternatives or additionally.

When the check-box 701 is set so as to use the function and the state becomes such that at least the destination settings 703 are selected, the OK button 705 becomes pressable. Control is performed such that the OK button 705 is displayed to be grayed out and cannot be pressed if the facsimile transmission destination or the archiving destination of the destination settings 703 is not selected, irrespective of whether the check-box 701 is set so as to use the function.

A servlet script that configures a program for facsimile transmission and archiving to specific destinations that is installed in the extension application unit 310 operates as follows when the conditions are satisfied and the OK button 705 is pressed. Firstly, all of the setting values are stored, via the VM/FW unit 309, in a region for facsimile transmission and archiving to specific destinations setting 1121 which is assigned in the region for extension applications (extension region) 1120 illustrated in FIG. 11. A state in which the setting content illustrated in FIG. 7 is stored is illustrated in the example of FIG. 11. Simultaneously, the extension application unit 310 makes a request to the VM/FW unit 309 so as to cause the UI unit 302 to display a button for executing facsimile transmission and archiving to specific destinations. The UI unit 302, having accepted the button display request from the VM/FW unit 309, displays a button for executing facsimile transmission and archiving to specific destinations on the home screen using an icon image saved in the Storage unit 306 in advance. Here, the UI unit 302 is an example of a display control unit.

An example in which a button for a facsimile transmission and archiving to specific destinations is displayed on the home screen is illustrated in FIG. 8. A button 801 in the bottom-left corner is the button for facsimile transmission and archiving to specific destinations. On the button 801, the button display name set by the button display name 702 is displayed.

Here, in a case when the OK button 705 is pressed in a state in which the check-box 701 was not selected so as to not use the function, the MFP 10 of the present embodiment suppresses the display of the button 801. To realize this, a program installed in the extension application unit 310 makes a request to the VM/FW unit 309 so that the button 801 is not caused to be displayed on the UI unit 302.

<Reservation and Transmission of Facsimile Transmission to Specific Destination>

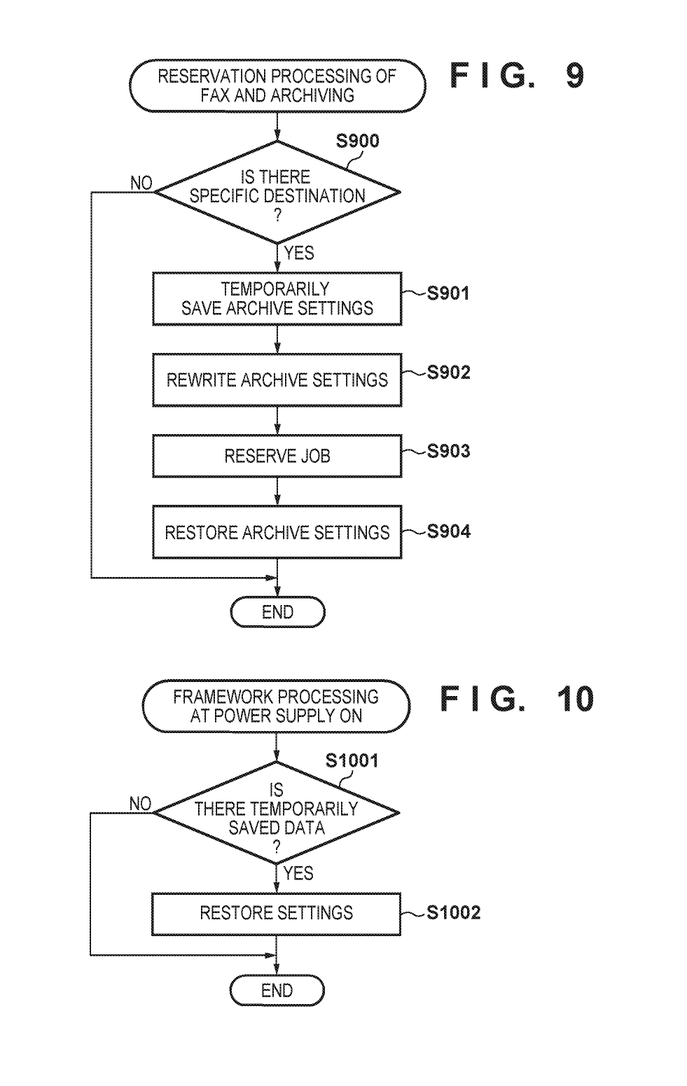

Next, with reference to FIG. 9, a processing procedure (memory control) for reservation of facsimile transmission and archiving to specific destinations according to an embodiment of the present invention is described. Note that the processing described below is realized by the CPU 101 executing a control program that is read from the ROM 102 or another storage unit and loaded into the RAM 103. The processing for reserving facsimile transmission and archiving to specific destinations may be realized by a main script that configures a program for facsimile transmission and archiving to specific destinations that is installed in the extension application unit 310.

Processing for reserving facsimile transmission and archiving to specific destinations is executed when the button 801 for facsimile transmission and archiving to specific destinations which is displayed on the home screen illustrated in FIG. 8 is pressed. Importance is attached to the program size of the extension application unit 310 and consistency of the facsimile transmission and archiving transmission processing in the MFP 10 of the present embodiment. Accordingly, the configuration is such that the function for facsimile transmission and archiving to specific destinations realized by the extension application unit 310 also uses the facsimile transmission processing illustrated in FIG. 6.

Firstly, in step S900, the CPU 101 determines whether or not there is a transmission of image data to a specific transmission destination when a job for transmitting image data is instructed by a user. Here, the determination is based on the button that the user operated to instruct the job for transmitting image data. Specifically, it is determined that there is a specific destination in the case when the button 801 for facsimile transmission and archiving to specific destinations is pressed. If the result of the determination is that there is a specific destination, the processing proceeds to step S901, and otherwise, the processing is terminated. Note that in the case when there is a normal transmission destination, the flowchart of FIG. 6 is executed without performing the memory control of step S901 through step S904. In step S901, the CPU 101 makes a request to the VM/FW unit 309 for a temporary saving of the archive settings. The VM/FW unit 309, having received this request, causes the setting values saved in the region for the archive settings 1111 illustrated in FIG. 11 to be temporarily saved in a region for archive settings 1131 assigned in the save region 1130.

Next, in step S902, the CPU 101 sets the content of an archiving switch in a region of the archive settings 1111 to be “perform”. Also, the content of an archiving destination in a region of the archive settings 1111 is rewritten to content of the archive destination in a region of the facsimile transmission and archiving to specific destinations setting 1121.

Next, the CPU 101 in step S903 reads setting values related to scanning and a facsimile destination stored in the facsimile transmission and archiving to specific destinations setting 1121, and collects them in a parameter for a facsimile transmission job. Then, using the parameter into which they are collected, the CPU 101 makes a reservation for a facsimile transmission job to the job controller 303 via the VM/FW unit 309.

When the reservation is completed, the CPU 101 in step S904 makes a request to the VM/FW unit 309 to restore the setting values that were temporarily saved in the archive settings 1131 in step S901 in the region of the archive settings 1111. The VM/FW unit 309 executes the actual restoration processing. As described previously, step S601 is executed substantially simultaneously to the completion of step S903, and the latching of the archive settings has already terminated when step S904 is executed. The VM/FW unit 309 clears the region of the archive settings 1131 with a disable value and terminates the processing when the restoration completes.

For the facsimile transmission job reserved in step S903, facsimile transmission and archiving transmission is performed by the processing illustrated in FIG. 6, similarly to the normal facsimile transmission job reserved in step S502.

<Processing at a Time of Power Supply Activation>

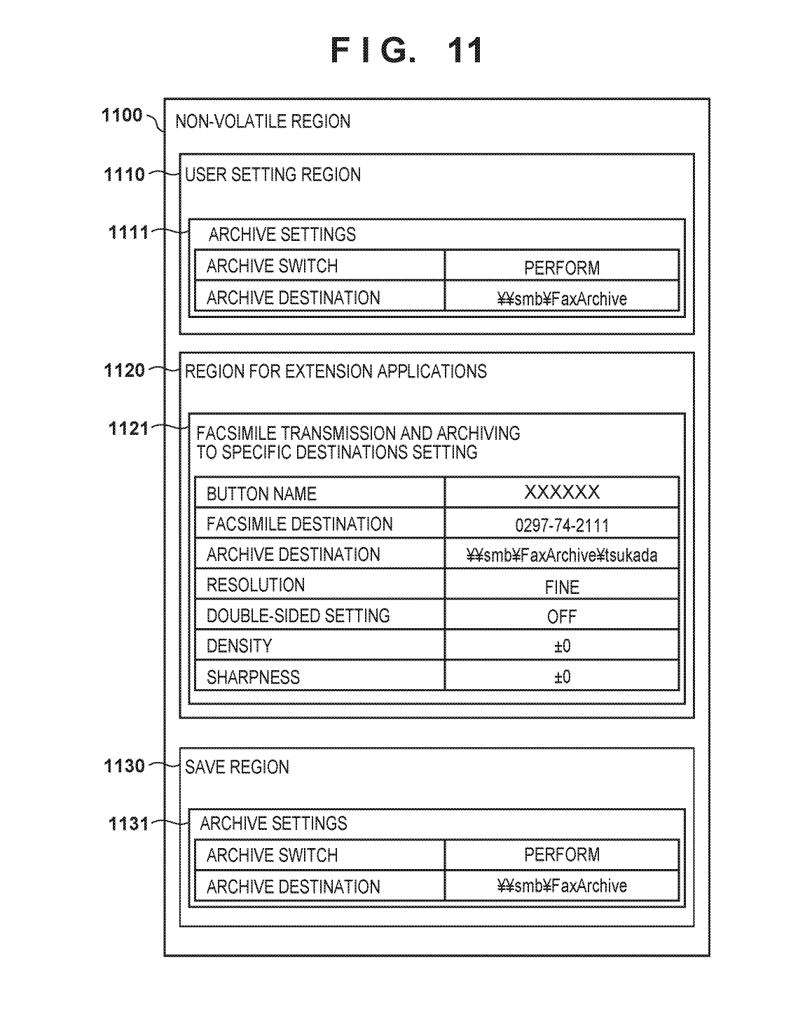

Next, with reference to FIG. 10, description is given of a processing procedure of a framework of the VM/FW unit 309 at a time of power supply activation in an embodiment of the present invention. Note that the processing described below is realized by the CPU 101 executing a control program that is read from the ROM 102 or another storage unit and loaded into the RAM 103.

As illustrated in FIG. 9, the function for facsimile transmission and archiving to specific destinations in the present embodiment is realized by rewriting the archive settings 1111 of FIG. 11 temporarily. For example, in the case when the power supply is disconnected in the period from when the processing of step S901 finishes to when step S904 is executed, the archive settings 1111 are changed to the setting values of the facsimile transmission and archiving to specific destinations settings 1121. Operation of the framework when the power supply is turned ON which is described using FIG. 10 is a recovery process in relation to this.

When the power supply is input, the CPU 101, in step S1101, determines whether or not temporarily saved data exists in a region of the archive settings 1131 assigned in the save region 1130, by the framework of the VM/FW unit 309. If there is temporarily saved data, the processing proceeds to step S1002, and if not, the processing of the framework for when the power supply is turned ON is terminated without doing anything. For example, because the save region 1130 is cleared by the disable value when the restoration of the saved archive setting is completed in step S904 described above, it is possible to determine that temporarily saved data exists if there is a setting that is other than the disable value in the archive settings 1131.

The CPU 101 in step S1002 restores, to the region of the archive settings 1111 assigned in the user setting region 1110, the data that was temporarily saved to the region of the archive settings 1131 assigned in the save region 1130. If the restoration is complete, the region of the archive settings 1131 is cleared with the disable value. By this, even in the case when the power supply is disconnected part way through, the values of the archive settings 1111 will return to what they originally were.

As described above, the image processing apparatus according to the present embodiment saves to a predetermined first destination archive data of transmitted image data if the transmission destination of the job is a normal transmission destination. Meanwhile, the image processing apparatus saves archive data of transmitted image data to a second destination if the transmission destination of the job is a specific transmission destination. By this, in the present embodiment, it is possible to execute transmission of image data and saving of archive data to specific destinations by a simple operation, and it becomes possible to provide an image processing apparatus in which it is possible to select an archive destination that is different than normal for only a time of transmitting image data to a specific destination. Furthermore, it becomes possible to realize this function without changing the conventional software structure.

### Other Embodiments

In the foregoing first embodiment, facsimile transmission and corresponding archive transmission to specific destinations was described as an example. However, the image data transmission protocol in the present invention is not limited to facsimile machines. For example, it is also possible to apply the present invention if the image data transmission protocol is email.

Also, something that can select a CIFS folder, an FTP path, an email address, and a fax number as archive destinations is described as an example in the first embodiment. However, the archive transmission protocol in the present invention is not limited to these. For example, it is possible to apply the present invention even to archive a transmission to IFAX or WebDAV.

Also, in the first embodiment, the image processing apparatus comprises a VM that can interpret and execute a scripting language, and that realizes the function for facsimile transmission and corresponding archiving to specific destinations by an extension application program described in the scripting language. However, the function for facsimile transmission and corresponding archiving to specific destinations can be realized even with pure embedded software, and it is possible to apply the present invention to pure embedded software.

Also, configuration in the first embodiment is such that the contents of the archive destination of the facsimile transmission and archiving to specific destinations setting 1121 of FIG. 11 are updated to an archive destination of a region of the archive settings 1111 assigned in the user setting region 1110. This, as mentioned previously, is because importance is attached to the program size of the extension application unit 310, and the consistency of the processing of facsimile transmission and archiving transmission, and the facsimile transmission processing of FIG. 6 is used even in the function of facsimile transmission and archiving to specific destinations. Meanwhile, it is possible to obtain the fundamental effect of the present invention even by configuring as follows, for example. Specifically configuration may be taken so as to latch related archive settings immediately prior to step S502 of FIG. 5 and step S903 of FIG. 9, without latching the archive settings in step S601 of FIG. 6. Also, it is possible to obtain a similar effect even in the case when the processing of step S901, step S902, and step S904 is not executed, if configuration is taken to include the content of the latched archive settings in the job reservation parameter. In such a case, it is possible to provide a region for storing information for a normal transmission destination and a region for storing information for a specific transmission destination separately in the non-volatile region 1100, and to latch the respective regions based on a transmission destination at the stage of making a reservation for a job to the job controller 303.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-047367 filed on Mar. 10, 2016, which is hereby incorporated by reference herein in its entirety.

What is claimed is:

1. An image processing apparatus, comprising:
a setting unit configured to set, as storage destinations for storing image data as a transmission history, a first external storage destination and a second external storage destination;
an acceptance unit configured to accept a transmission destination of image data;
a transmission unit configured to transmit image data to the transmission destination accepted by the acceptance unit; and
a storage control unit configured to store the image data in the first external storage destination in accordance with the transmission destination of the image data not being a specific destination, and to store the image data to the second external storage destination in accordance with the transmission destination of the image data being the specific destination.

2. The image processing apparatus according to claim 1, further comprising:
a registration unit configured to register the specific destination, wherein
the storage control unit stores the image data in the second external storage destination in accordance with the transmission destination of the image data being the specific destination registered by the registration unit.

3. The image processing apparatus according to claim 2, further comprising:
a display unit configured to display a button for setting, as the transmission destination of the image data, the specific destination registered by the registration unit.

4. The image processing apparatus according to claim 3, further comprising:
a destination setting unit configured to set, as the transmission destination of the image data, the specific destination registered by the registration unit, in accordance with an operation on a button displayed by the display unit.

5. The image processing apparatus according to claim 1, further comprising
a destination reception unit configured to receive the specific destination via a network from an external apparatus.

6. The image processing apparatus according to claim 1, further comprising
a storage destination information reception unit configured to receive information indicating the second external storage destination via a network from an external apparatus.

7. The image processing apparatus according to claim 1, further comprising
a reading unit configured to generate image data by reading an original, wherein
the transmission unit transmits the image data generated by the reading unit to the transmission destination accepted by the accepting unit.

8. A control method for controlling an image processing apparatus comprising:
setting, as storage destinations for storing image data as a transmission history, a first external storage destination and a second external storage destination;
accepting a transmission destination of image data;
transmitting image data to the accepted transmission destination; and
storing the image data in the first external storage destination in accordance with the transmission destination of the image data not being a specific destination, and storing the image data to the second external storage destination in accordance with the transmission destination of the image data being the specific destination.

9. A non-transitory computer readable storage medium for storing a computer program for controlling an image processing apparatus, the computer program comprising:
code that sets, as storage destinations for storing image data as a transmission history, a first external storage destination and a second external storage destination;
code that accepts a transmission destination of image data;
code that transmits image data to the accepted destination; and
code that stores the image data in the first external storage destination in accordance with the transmission destination of the image data not being a specific destination, and stores the image data to the second external storage destination in accordance with the transmission destination of the image data being the specific destination.
